(19) United States
(12) Patent Application Publication
(10) Pub. No.: US 2012/0166946 A1
(43) Pub. Date: Jun. 28, 2012

(54) DYNAMIC HANDLING OF INSTRUCTIONAL FEEDBACK ELEMENTS BASED ON USAGE STATISTICS

(76) Inventor: JENS BOMBOLOWSKY, Schwetzingen (DE)

(21) Appl. No.: 12/976,840

(22) Filed: Dec. 22, 2010

(51) Int. Cl. G06F 3/048

(52) U.S. Cl. 715/708

(57) ABSTRACT

Historical data representative of past interactions of a user of a computer application with a user interface screen of the computer application can be retained, for example for later analysis to determine whether to present one or more instructional feedback elements associated with the user interface screen or with a user interface element within the user interface screen. Upon detecting a current navigation of the user to the user interface screen, a determination can be made whether to present an instructional feedback element. The instructional feedback element can be presented if the historical data indicate at least one factor suggestive of a need by the user for assistance with the user interface screen or with the user interface element within the user interface screen. The instructional feedback element can be hidden if the historical data do not indicate any of the at least one factors. Computer program products, systems, and methods having similar features are also described.

### TECHNICAL FIELD

The subject matter described herein relates to handling of screen explanation texts and/or other help messages, for example in a user interface associated with one or more application programs.

### BACKGROUND

Explanation texts or other guidance-providing user interface elements can typically be displayed on user interface screens of an application program to provide instructional directions for users of the screen, for example regarding how to use features such as other user interface elements, functions, commands, and the like, data values or types of data to enter in a user interface element, etc. For convenience, the term instructional feedback element is used throughout the remainder of this disclosure to refer to any kind of explanation texts or other guidance-providing user interface elements or other feedback, including but not limited to textual advice or instructions, visible or audible prompts, animated or static images, hypertext or other types of links to help pages, and the like.

As an illustrative example, an instructional feedback element can provide guidance during creation of a sales order that on a first screen of a user interface advises a user that a number or other identifier for the account to which the sales order is to be charged will be required on a screen displayed subsequently during the sales order screen creation sequence. A valid account having such an identifier is therefore implicitly required to be already available. Once the user continues to the next screen in a sequence, an instructional feedback element could further explain that one or more documents can be attached to the sales order, etc.

An instructional feedback element may be designed to give additional clarifying information or other non-essential details to a user that can improve understanding of the underlying process that is associated with the user interface sequence. While a well designed user interface sequence can be designed to be mostly self-explanatory to a user, particularly after repeated use, instructional feedback elements are often included as a default feature whose display can consume screen space that a more experienced user might prefer to not be used in that manner.

### SUMMARY

In one aspect, a computer-implemented method includes retaining historical data representative of past interactions of a user of a software application with a user interface screen of the software application. A current navigation of the user to the user interface screen is detected, and a determination is made whether to present an instructional feedback element associated with the user interface screen. The determining includes presenting the instructional feedback element if the historical data indicate at least one factor suggestive of a need by the user for assistance with the user interface screen or with a user interface element within the user interface screen and not presenting the instructional feedback element if the historical data do not indicate any of the at least one factor suggestive of the need by the user for assistance.

In some variations one or more of the following can optionally be included. The at least one factor can be selected from a most recent prior navigation by the user to the screen occurring earlier than a first threshold time before the current navigation, a first metric of unsuccessful prior interactions by the user with the user interface screen or with the user interface element within the user interface screen, and a second metric indicating which fields on the user interface screen are filled and an order in which the fields are filled. The determining can further include quantifying the first metric of unsuccessful prior interactions by the user. The quantifying can include at least one of a time spent by the user on the user interface screen exceeding a threshold time, instances of triggering of a warning or error message by the user's interactions with the user interface screen, completions the user completes of at least one task associated with the user interface screen or user interface element in an inefficient manner. The determining can also or alternatively further include applying a complexity parameter associated with the user interface screen or with the user interface element. The complexity parameter can be defined at design time and can represent an estimation of an expected difficulty the user might have in correctly interacting with or otherwise completing tasks associated with the user interface screen or the user interface element. The determining can also or alternatively further include applying an importance parameter associated with the user interface screen or with the user interface element. The importance parameter can be defined at design time and can represent an estimation of how important the user interface screen or user interface element are expected to be in productive use of the software application. The determining can also or alternatively further include assessing whether a feature of the user interface screen or user interface element were added or changed as part of a new software release, service pack, or update, and if so, presenting the instructional feedback element associated with the user interface screen or user interface element even if the historical data do not indicate a need for presentation of the instructional feedback element. Upon determining that an addition or change to the feature of the user interface screen or user interface element as part of the new software release, service pack, or update is a major change, the historical data can be adjusted reflect that the user has never before interacted with the user interface screen or user interface element.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The subject matter described herein provides many advantages. For example, instructional feedback elements associated with a user interface screen or user interface elements on a user interface screen can be presented to a user in an adaptive and personalized manner based on one or more algorithms that dynamically determine whether the instructional feedback elements are likely to be helpful to the user. In contrast to other approaches that typically rely on global settings that may not provide sufficient granularity to provide assistance for certain user interface screens or user interface elements where help is most needed or that are static and therefore not dynamically adaptable to account for the user's actual success at interacting with features of a software application or computer system, the current subject matter can automatically and intelligently change the determination of whether to present an instructional feedback element based on actual usage statistics or other historical data representative of the user's interaction with the software application or computer system.

It should be noted that, while the descriptions of specific implementations of the current subject matter may discuss delivery of enterprise resource planning software to one or more organizations, the current subject matter is applicable to other types of software and data services access as well. These examples are not meant to be limiting unless explicitly so stated in the foregoing description. The scope of the subject matter claimed below therefore should not be limited except by the actual language of the claims.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a screenshot showing an example of display of fixed instructional feedback elements in a user interface;

FIG. 2 is a screenshot showing an example of display of rollover instructional feedback elements in a user interface;

FIG. 3 is a screenshot showing an example of display of fixed and rollover instructional feedback elements in a user interface;

FIG. 4 is a screenshot showing an example of a user interface with no instructional feedback elements displayed;

FIG. 5 is a process flow diagram illustrating aspects of a method consistent with at least some implementations of the current subject matter; and

FIG. 6 is a system diagram showing a system consistent with at least some implementations of the current subject matter.

When practical, similar reference numbers denote similar structures, features, or elements.

### DETAILED DESCRIPTION

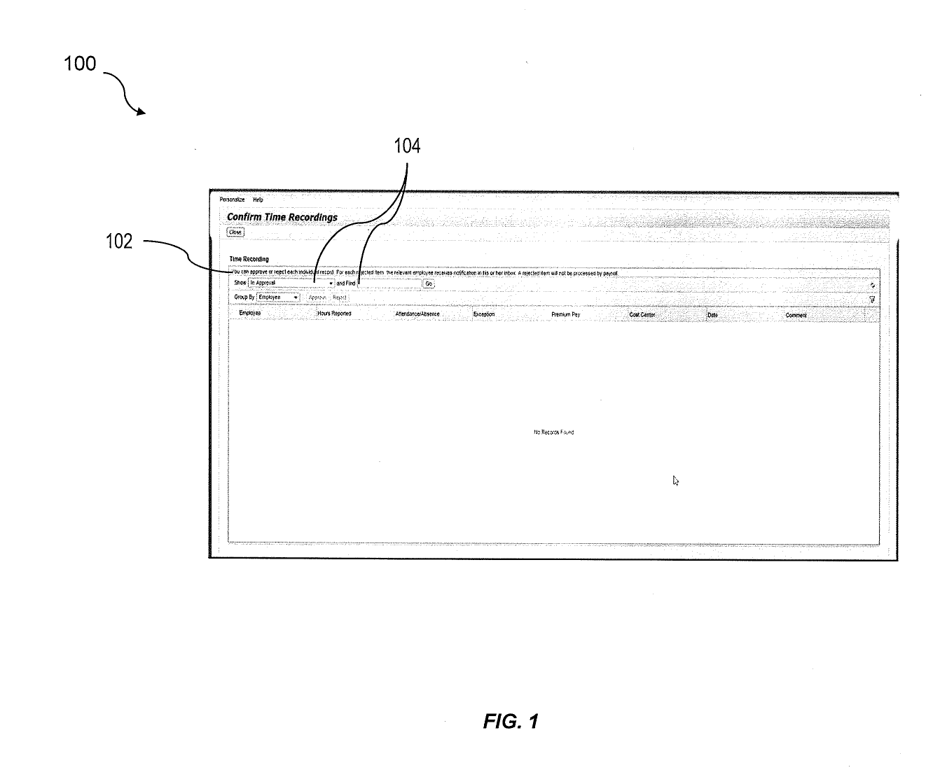

One type of instructional feedback element is an on-screen explanation text or other fixed visual display 102 that can explain the purpose, impact, etc. of a particular screen or part of a screen. An example of an instructional feedback element having a fixed visual display 102 is shown in the screenshot 100 displayed in FIG. 1. Instructional feedback elements can be associated generally with a user interface screen or more specifically with one or more user interface element 104 displayed on a user interface screen.

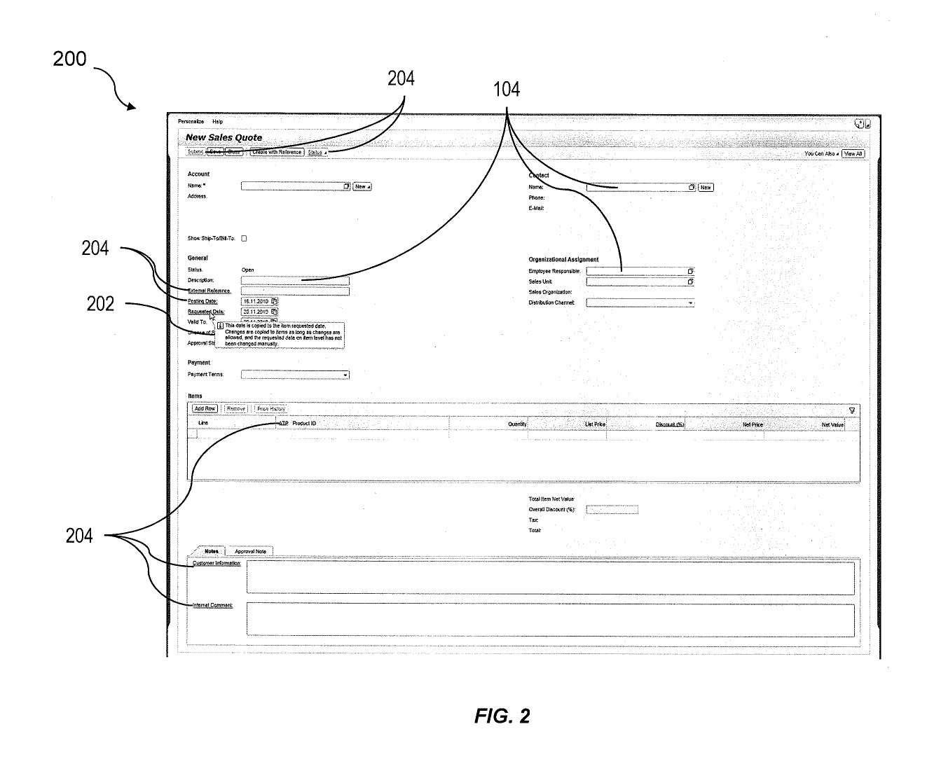

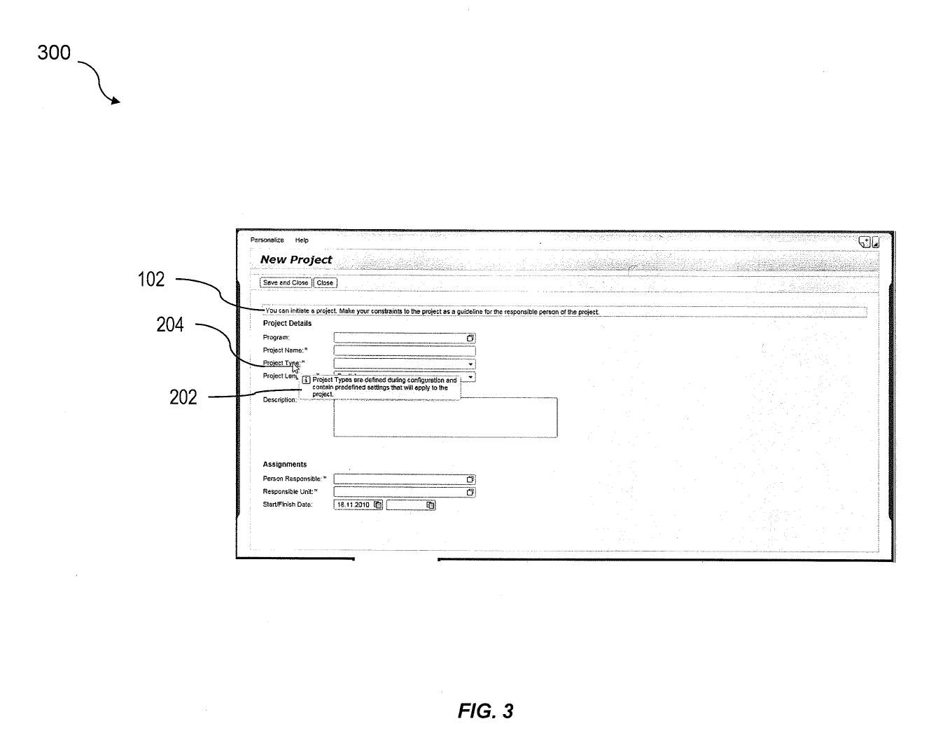

Another example of an instructional feedback element is a rollover explanation or display 202, which can also be referred to as a “mouseover,” an example of which is shown in the screenshot 200 displayed in FIG. 2. A rollover explanation or display 202 can explain the purpose, impact, etc. of a field, a function, a tab, a table column header, or the like, and can be associated with a user interface element such as a field label, a button, a tab, a table column header, and the like. In some examples, user interface elements with an associated rollover explanation or display 202 can have an underline or other visual indicator 204 that further explanation is available. When the user points the mouse cursor on the field label or button, the rollover explanation or display 202 can be displayed. Underlines or other visual indicators 204 of the availability of a rollover explanation or display 202 can be displayed by default is some systems. The user can switch them off via personalization. FIG. 3 shows a screenshot 300 of a user interface in which instructional feedback elements having a fixed visual display 102 and a rollover explanation or display 202 with visual indicators (e.g. underlined text) 204 of their availability.

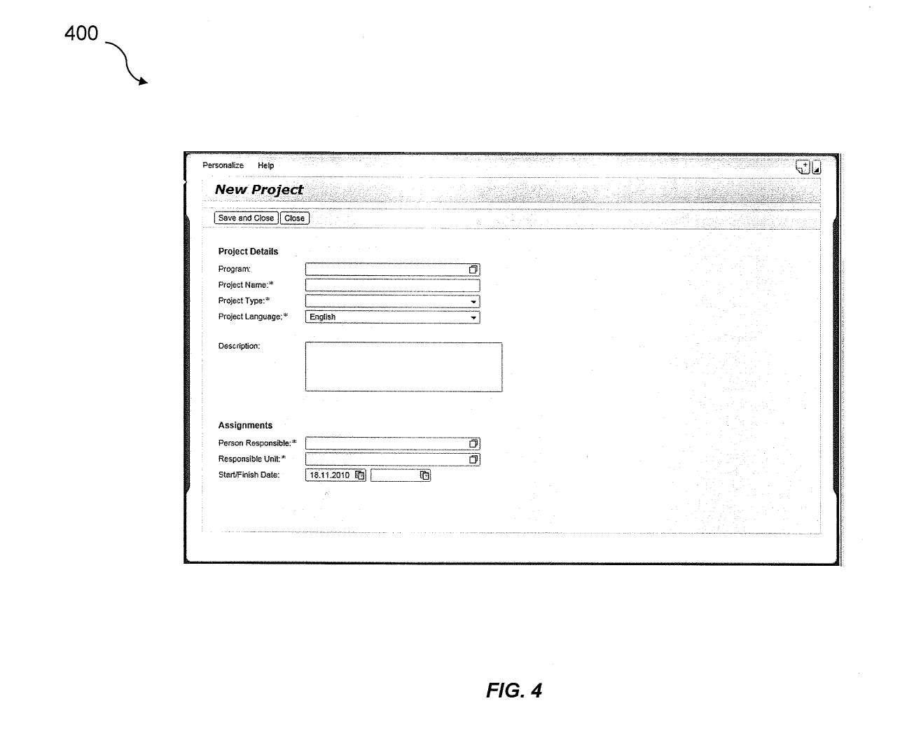

Software programs and applications often include functionality via which a user can centrally disable instructional feedback elements, for example by displaying a dialog box, check box, or other user interface element querying or otherwise allowing entry of a user preference indicating whether to disable the instructional feedback element on a subsequent visit by the user to the screen. By activating such functionality, the user cause instructional feedback elements to no longer appear or otherwise provide guidance on any user interface screens of the applicant, program, system, etc. While enabling a user to decide on a screen by screen basis whether to disable instructional feedback elements for each such screen, such an approach can be disadvantageous as it requires additional user interaction on each screen as well as the addition of a user interface element tasked with toggling the enabling or disabling of such instructional feedback elements. FIG. 4 shows a screenshot 400 of a user interface in which all instructional feedback elements have been manually turned off by a user, for example using a control panel, settings entry screen, or the like.

Other options for handling disabling and/or enabling of user interface elements can include functionality that hides rarely used functions. Such approaches generally determine whether to show or display functions or user elements based on whether the user has interacted with the functions or user elements without consideration for whether the interactions are successful or unsuccessful or even intentional or for whether the function or user element is important despite being rarely used.

Central enabling and disabling of instructional feedback elements can cause problems for a user who only rarely interacts with certain functionality of the software. For example, a task that is performed intermittently and infrequently might not be as familiar to the user and enabling of instructional feedback elements while navigating through user interface screens related to this task might be useful, even to an experienced user who would otherwise prefer that instructional feedback elements are disabled on user interface screens that are more frequently and regularly used. If instructional feedback elements have been previously globally disabled, the user might not recall or otherwise realize that additional guidance is available in such an instance.

Difficulties can also arise with allowing a user to selectively disable instructional feedback elements on an element by element or screen by screen basis. Such an approach can require the user to predict when he or she is likely to revisit the screen. For example, if the user returns to the screen within a few weeks, providing the instructional feedback element or elements on the subsequent visit might be unnecessary. However, if the user does not return to the screen for a longer period, on a subsequent visit it is more likely that providing the instructional feedback elements would be useful. Another issue with allowing selective disabling of instructional feedback elements is related to the number of instructional feedback elements that can potentially be available. Instructional feedback elements can exist both for entire screens and for specific user interface elements, including but not limited to buttons, database columns, text entry fields, pulldown menus, and the like. Presenting a user with a choice whether to enable disable an instructional feedback element for each screen or screen element can be quite overwhelming and can distract from the main intent of a user interface—to enable the user to perform useful transactions, productive work, etc. If an enable/disable decision is presented at the screen level, a user might choose to disable instructional feedback elements for a screen with which he or she is very familiar and thereby disable instructional feedback elements related to an important but rarely used element with which he or she has never or only rarely interacted and for which he or she might benefit from being provided with a related instructional feedback element.

Relying on automated approaches or user-entered preferences for determination of whether instructional feedback elements should or should not be presented can lead to a user forgetting about the existence of one or more instructional feedback elements that are not currently available, either because they were locally or globally disabled by previous entry of a user preference or because they have not been frequently used. As such instructional feedback elements are likely to be of most help to a user who does not frequently use them, this can lead to inefficiencies. Even if a user is able to reactivate an instructional feedback element that has been previously disabled, doing so can cause a distraction from the user's intended task, either due to needing to navigate away from a screen or a user element related to the intended task to change a preference for instructional feedback element display. Further inconvenience can arise if the user must then perform one or more actions to re-disable one or more instructional feedback elements, for example after completion of a rarely performed action, function, etc.

To address these and potentially other issues with currently available solutions, one or more implementations of the current subject matter provide methods, systems, articles or manufacture, and the like that personalizes instructional feedback element display based on analysis of a user's interaction with a user interface. In some implementations, rather than requiring a user to choose whether to enable or disable instructional feedback elements on a global basis for all user interface screens or one a screen by screen or element by element basis, one or more algorithms can be used to determine a probability that presentation of instructional feedback elements associated with an individual screen or with an individual user interface element basis will be beneficial. The probability can be determined based on analysis of user-specific usage statistics, for example to identify whether a user has previously interacted with one or more user interface elements or screen, when such interaction last occurred, a degree of success associated with the previous interactions, and the like.

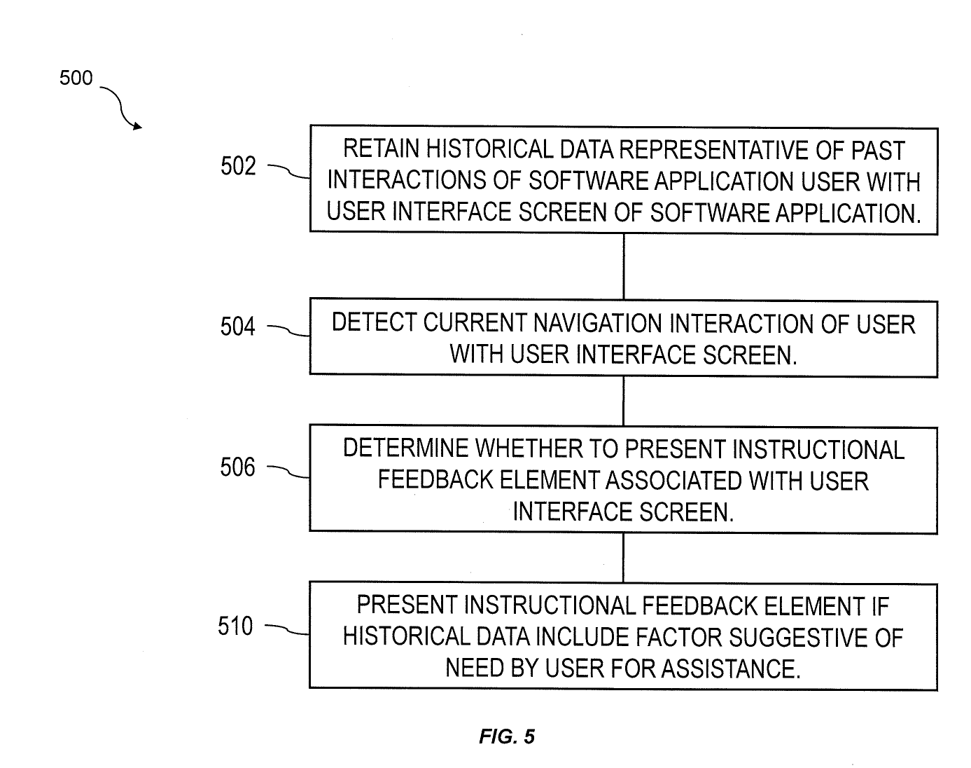

FIG. 5 shows a process flow chart 500 illustrating features of a method consistent with implementations of the current subject matter. At 502, historical data representative of past interactions of a user of a computer application with a user interface screen of the computer application can be retained, for example in a database or in computer storage or memory. At 504, a current navigation of the user to the user interface screen is detected. The current navigation can include one or more of navigating to a new screen, performing a user interface action (e.g. activating or selecting a user interface element, mousing over a user interface element, entering one or more keyboard commands, entering data, or the like) on an existing screen, entering a URL or other navigation target for a new user interface screen, returning to a previously visited user interface screen, completing a task associated with a user interface screen or user interface element, etc. A determination is made at 506 whether to present an instructional feedback element associated with the user interface screen. The determining can be include presenting the instructional feedback element if the historical data indicate at least one factor suggestive of a need by the user for assistance with the user interface screen or with a user interface element within the user interface screen. The instructional feedback element is not presented if the historical data do not indicate any of the at least one factor suggestive of the need by the user for assistance.

The at least one factor can be one or more of a most recent prior navigation by the user to the screen occurring earlier than a threshold time before the current navigation, a metric indicating greater than a threshold number of unsuccessful prior interactions by the user with the user interface screen or with the user interface element within the user interface screen.

In some implementations, a user interface control can be provided via which a user can activate an option to present instructional feedback elements based on usage statistics. On first use by the user of a computer application with this option activated, all instructional feedback elements associated with all screens can be enabled for presentation in their appropriate contexts. As the user begins interacting with features of the computer application and using user interface elements and user interface screens, usage statistics can be written to a database or otherwise retained for analysis. Non-limiting examples of historical data can include a metric of how long a user remains at a specific screen after navigating to the screen, whether the user successfully completes one or more tasks associated with the user interface screen or with one or more user interface elements within the user interface screen, whether any warnings or error messages are triggered by the user's actions while on the screen, whether the user completes one or more tasks associated with the user interface screen in a most efficient manner (i.e., sequentially from field to field in a logical order or the like as opposed to jumping back and forth between elements), which functions or features are executed or interacted with on the user interface screen, which fields on the user interface screen are filled and how they are filled, whether user interface elements are read or viewed or shown (e.g. as detected by a cursor being held at or near the user interface element, or the like.

In an illustrative example, a user creating a new sales order can enter data and fill the interface fields in a variety of ways. The user can enter an ID for the customer name (which can be automatically transformed into the name of the account/customer name), use an auto-complete feature while typing the complete name, use a value help feature to display a secondary window to look for available accounts, or the like. For entering dates, the user can use a calendar control to pick a date, or type in the date directly. Information regarding the manner in which the user enters data into the fields can be analyzed to infer the experience level of the user, in general, and in relation to the specific screen.

In some implementations, a software designer can define one or more complexity parameters representing an estimation of the difficulty a user might have in correctly interacting with or otherwise completing tasks associated with a user interface screen and/or one or more user interface elements on the screen. Alternatively or in addition, an importance parameter can be associated with one or more user interface screens and/or user interface elements to define how important the user interface screen or user interface element are expected to be in productive use of the software application or computer system. The complexity parameter and/or importance parameter can also be included as part of the determining whether to present instructional feedback element or elements associated with a user interface screen or user interface element.

In some implementations, the determining of whether to present an instructional feedback element or elements associated with a user interface screen or user interface element can also consider whether one or more features of the user interface screen or user interface element were added or changed as part of a new software release, service pack, or update. In some examples, instructional feedback element or elements associated with changed user interface screens or user interface elements can be shown again but for only a limited time if the changes are minor. For more substantial changes, the instructional feedback element or elements can be shown as for screens that the user has never before used.

In some implementations, a multivariate analysis can be used to determine whether to display instructional feedback elements associated with a user interface screen or user interface element. Multiple variables, potentially including but not limited to time elapsed since the last visit by the user to the user interface screen, a degree of success associated with previous interactions of the user with the user interface screen or user interface element, a relative complexity of a task associated with the user interface screen or user interface element, and the like can be analyzed to determine whether the one or more variables considered as a whole indicate a need for display of one or more instructional feedback elements.

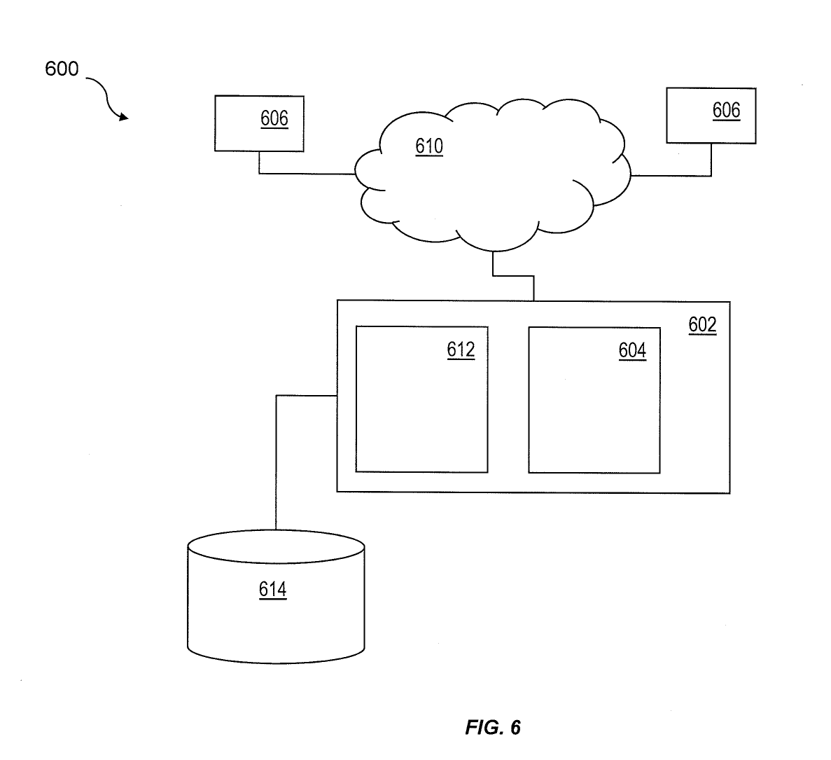

FIG. 6 shows an example of a system 600 consistent with the current subject matter. A computing system 602 that can include one or more programmable processors, which can be collocated, linked over one or more networks, etc., can execute one or more first modules 604 that provide one or more ERP or other software application functions accessible to local users as well as remote users accessing the computing system 602 from one or more client machines 606 over a network connection 610. One or more user interface screens produced by the one or more first modules can be displayed to a user, either via a local display or via a display associated with one of the client machines 606. Interactions of a user with the one or more user interface screens can be monitored by a monitor module 612 that retains, for example in a database 614, historical data representative of past interactions of the user with the user interface screen or screens of the software application. Based on these historical data and a detection of a current navigation of the user to a user interface screen, the monitor module 612 can determine whether to present an instructional feedback element associated with the user interface screen. If so, the instructional feedback element can be presented with the user interface screen displayed to the user.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
retaining historical data representative of past interactions of a user of a software application with a user interface screen of the software application;
detecting, by the at least one processor, a current navigation interaction of the user with the user interface screen;
determining whether to present an instructional feedback element associated with the user interface screen, the determining comprising analyzing whether the historical data comprise a factor suggestive of a need by the user for assistance with at least one of the user interface screen and a user interface element within the user interface screen; and
presenting the instructional feedback element if the historical data comprise the factor and not presenting the instructional feedback element if the historical data do not comprise the factor.

2. A computer program product as in claim 1, wherein the at least one factor is selected from a most recent prior navigation by the user to the screen occurring earlier than a first threshold time before the current navigation, a first metric of unsuccessful prior interactions by the user with the user interface screen or with the user interface element within the user interface screen, and a second metric indicating which fields on the user interface screen are filled and an order in which the fields are filled.

3. A computer program product as in claim 2, wherein the determining further comprises quantifying the first metric of unsuccessful prior interactions by the user, the quantifying comprising at least one of a time spent by the user on the user interface screen exceeding a threshold time, instances of triggering of a warning or error message by the user's interactions with the user interface screen, completions the user completes of at least one task associated with the user interface screen or user interface element in an inefficient manner.

4. A computer program product as in claim 1, wherein the determining further comprises applying a complexity parameter associated with the user interface screen or with the user interface element, the complexity parameter being defined at design time and representing an estimation of an expected difficulty the user might have in correctly interacting with or otherwise completing tasks associated with the user interface screen or the user interface element.

5. A computer program product as in claim 1, wherein the determining further comprises applying an importance parameter associated with the user interface screen or with the user interface element, the importance parameter being defined at design time and representing an estimation of how important the user interface screen or user interface element are expected to be in productive use of the software application.

6. A computer program product as in claim 1, wherein the determining further comprises assessing whether a feature of the user interface screen or user interface element were added or changed as part of a new software release, service pack, or update, and if so, presenting the instructional feedback element associated with the user interface screen or user interface element even if the historical data do not indicate a need for presentation of the instructional feedback element.

7. A computer program product as in claim 6, further comprising:
determining whether an addition or change to the feature of the user interface screen or user interface element as part of the new software release, service pack, or update is a major change or a minor change; and
adjusting the historical data to reflect that the user has never before interacted with the user interface screen or user interface element if the addition or change is the major change.

8. A system comprising:
at least one processor; and
at least one machine-readable medium storing instructions that, when executed by the at least one programmable processor, cause the at least one programmable processor to perform operations comprising:
retaining historical data representative of past interactions of a user of a software application with a user interface screen of the software application;
detecting a current navigation of the user to the user interface screen;
determining whether to present an instructional feedback element associated with the user interface screen, the determining comprising presenting the instructional feedback element if the historical data indicate at least one factor suggestive of a need by the user for assistance with the user interface screen or with a user interface element within the user interface screen and not presenting the instructional feedback element if the historical data do not indicate any of the at least one factor suggestive of the need by the user for assistance.

9. A system as in claim 8, wherein the at least one factor is selected from a most recent prior navigation by the user to the screen occurring earlier than a first threshold time before the current navigation, a first metric of unsuccessful prior interactions by the user with the user interface screen or with the user interface element within the user interface screen, and a second metric indicating which fields on the user interface screen are filled and an order in which the fields are filled.

10. A system as in claim 9, wherein the determining further comprises quantifying the first metric of unsuccessful prior interactions by the user, the quantifying comprising at least one of a time spent by the user on the user interface screen exceeding a threshold time, instances of triggering of a warning or error message by the user's interactions with the user interface screen, completions the user completes of at least one task associated with the user interface screen or user interface element in an inefficient manner.

11. A system as in claim 8, wherein the determining further comprises applying a complexity parameter associated with the user interface screen or with the user interface element, the complexity parameter being defined at design time and representing an estimation of an expected difficulty the user might have in correctly interacting with or otherwise completing tasks associated with the user interface screen or the user interface element.

12. A system as in claim 8, wherein the determining further comprises applying an importance parameter associated with the user interface screen or with the user interface element, the importance parameter being defined at design time and representing an estimation of how important the user interface screen or user interface element are expected to be in productive use of the software application.

13. A system as in claim 8, wherein the determining further comprises assessing whether a feature of the user interface screen or user interface element were added or changed as part of a new software release, service pack, or update, and if so, presenting the instructional feedback element associated with the user interface screen or user interface element even if the historical data do not indicate a need for presentation of the instructional feedback element.

14. A computer program product as in claim 13, further comprising:
determining whether an addition or change to the feature of the user interface screen or user interface element as part of the new software release, service pack, or update is a major change or a minor change; and
adjusting the historical data to reflect that the user has never before interacted with the user interface screen or user interface element if the addition or change is the major change.

15. A method comprising:
retaining, by at least one processing system, historical data representative of past interactions of a user of a software application with a user interface screen of the software application;
detecting, by the at least one processor, a current navigation of the user to the user interface screen;
determining, by the at least one processor, whether to present an instructional feedback element associated with the user interface screen, the determining comprising presenting the instructional feedback element if the historical data indicate at least one factor suggestive of a need by the user for assistance with the user interface screen or with a user interface element within the user interface screen and not presenting the instructional feedback element if the historical data do not indicate any of the at least one factor suggestive of the need by the user for assistance.

16. A method as in claim 15, wherein the at least one factor is selected from a most recent prior navigation by the user to the screen occurring earlier than a first threshold time before the current navigation, a first metric of unsuccessful prior interactions by the user with the user interface screen or with the user interface element within the user interface screen, and a second metric indicating which fields on the user interface screen are filled and an order in which the fields are filled.

17. A method as in claim 16, wherein the determining further comprises quantifying the first metric of unsuccessful prior interactions by the user, the quantifying comprising at least one of a time spent by the user on the user interface screen exceeding a threshold time, instances of triggering of a warning or error message by the user's interactions with the user interface screen, completions the user completes of at least one task associated with the user interface screen or user interface element in an inefficient manner.

18. A method as in claim 15, wherein the determining further comprises applying a complexity parameter associated with the user interface screen or with the user interface element, the complexity parameter being defined at design time and representing an estimation of an expected difficulty the user might have in correctly interacting with or otherwise completing tasks associated with the user interface screen or the user interface element.

19. A method as in claim 15, wherein the determining further comprises applying an importance parameter associated with the user interface screen or with the user interface element, the importance parameter being defined at design time and representing an estimation of how important the user interface screen or user interface element are expected to be in productive use of the software application.

20. A method as in claim 15, wherein the determining further comprises assessing whether a feature of the user interface screen or user interface element were added or changed as part of a new software release, service pack, or update, and if so, presenting the instructional feedback element associated with the user interface screen or user interface element even if the historical data do not indicate a need for presentation of the instructional feedback element.
